(19) United States
(12) Patent Application Publication
(10) Pub. No.: US 2002/0093881 A1
(43) Pub. Date: Jul. 18, 2002

(54) Digital vibration transducer

(76) Inventor: Gerry M. Kane, Montreal (CA)

Correspondence Address: MERCHANT & GOULD PC, P.O. BOX 2903, MINNEAPOLIS, MN, 55402-0903, US

(21) Appl. No.: 10/046,129

(22) Filed: Oct. 26, 2001

(30) Foreign Application Priority Data
Oct. 26, 2000 (CA) 2,324,572

(51) Int. Cl. H04R 1/00

(52) U.S. Cl. 367/149

(57) ABSTRACT

A digital vibration transducer for producing a digital signal representative of a vibration of a vibrating member is provided. The transducer includes a laser source producing a light beam that is focused on a detection area. The light beam is reflected towards this detection area by a reflector, at an angle with the optical axis of the light beam and pivotable about a pivot axis. A linkage assembly connects the vibrating member to the reflector to convert the vibrating of the vibration member into a pivoting of the reflector, thereby sweeping the reflected light beam across the detection area. A sensing and encoding assembly is provided in the detection area and produces the digital signal representative of the vibration of the vibrating member relatively to the sweeping of the light beam.

### FIELD OF THE INVENTION

The present invention relates to the field of transducers and more particularly concerns a vibration transducer that translates the vibration of a vibration source directly into a digital signal.

### BACKGROUND OF THE INVENTION

The art of analog transducers, such as generally used for speakers and microphones, suffers from a number of limitations. Among these limitations are dynamic range, distortion and, for microphones especially, noise.

“Dynamic range” describes the range of volume that a transducer can either detect or produce. A distinction should however be made between overall dynamic range and instantaneous dynamic range. Thus, while the human ear can easily have an overall dynamic range of 120 dB and can, in a quiet room, hear a pin drop at one time and at another time accurately hear the notes playing at a 120 dB rock concert, it cannot hear both sounds simultaneously. This is also true of analog microphones. If one raises the gain of a sensitive analog microphone high enough it can pick up the sound of a pin dropping. But one cannot then expect the same microphone, at the same gain, to cleanly detect sound at 120 dB. Conversely, an analog microphone attenuated enough to detect a 120 dB concert without clipping, that is cutting off the peaks of the waveforms, would be too insensitive to detect even normal conversation adequately. Like the human ear, an analog microphone cannot detect both a very loud sound and a soft sound simultaneously.

The second limitation of analog sound transducers is distortion, which has a relationship to dynamic range. Generally speaking, analog transducers have more distortion the higher they are in their dynamic range. Thus, the louder the sound entering a microphone or leaving a speaker, for example, the more likely it is to distort. A major source of this distortion is non-linear effects in the suspension of the sound sensing or sound invoking membrane. In order for a sound sensing or invoking membrane to have a rest position to which will go back to when there is no signal, the suspension must have an elastic, non-linear nature. That is, the farther the membrane is deviated from its rest position, the greater must be the opposing force of the suspension attempting to return it. It is well known that sound passing through a non-linear medium will suffer distortion as a result, and if the sound is composed of more than one frequency inter-modulation (IM) distortion results causing the introduction of tones not included in the original signal.

Additionally, analog transducers are subject to a lot of noise, such as often generated by the conversion of the data to electrical signal.

Digital vibration transducers are known in the art. For example, U.S. Pat. No. 3,286,032 (BAUM) discloses a digital microphone where the vibration of a membrane is directly translated into a digital signal. In one embodiment, BAUM teaches of a device having a vibrating membrane on which is directly affixed a reflecting mirror. A collimated light beam is impinged on this mirror from an angle, and reflected to a photosensitive device arranged in a code matrix. The movement of the membrane will change the position where the beam is reflected, resulting in the direct digital encoding of the translation movement of the membrane. However, the sensitivity of the device is severely limited by the provision of a mirror directly on the vibrating membrane, which does not provide any amplification of the original signal.

U.S. Pat. No. 4,422,182 (KENJYO) discloses a similar type of digital microphone. In this case, the mirror is integral to the vibrating membrane and the movement of this membrane will also change the angle of deflection of a laser beam. U.S. Pat. No. 5,566,135 (MacLEOD), also teaches a digital transducer where a mirror is directly mounted on a diaphragm. In this case, the mirror is embodied by a faceted reflective surface that reflects the laser beam incident thereon.

U.S. Pat. No. 4,061,556 (FULENWIDER) shows an optically encoded acoustic to digital transducer. This device includes a revolving mirror suspended at one end by a wire and attached at its opposite end to a vibrating membrane. The lever effect provided by this set up is however limited, and so is the sensitivity of the device. In addition, the encoding method used by FULENWIDER is complex and would not be appropriate for many typical applications.

U.S. Pat. No. 5,262,884 (BUCHHOLZ), U.S. Pat. No. 5,333,205 (BOGUT et al.), U.S. Pat. No. 5,705,809 (KERSHAW), U.S. Pat. No. 5,995,260 (RABE), U.S. Pat. No. 6,014,239 (VELIGDAN), U.S. Pat. No. 6,055,080 (F\ddot{UR}STENAU et al.), U.S. Pat. No. 6,147,787 (VELIGDAN), and U.S. Pat. No. 6,154,551 (FRENKEL), all disclose microphones where an optical beam is used to detect sound waves.

None of the above prior art patents however provides a versatile digital vibration transducer alleviating the drawbacks of their analog counterparts.

### OBJECTS AND SUMMARY OF THE INVENTION

It is therefore an object of the present invention to provide a versatile vibration transducer for converting a vibration of a vibration member directly into a digital signal.

Accordingly, the present invention provides a digital vibration transducer for producing a digital signal representative of a vibration of a vibrating member.

The transducer includes a laser light source for generating a light beam having an optical axis, and focusing means for focusing this light beam on a detection area. A reflector is disposed across the light beam and defines a reflecting plane at an angle from the optical axis. The reflector is pivotable with respect to a pivot axis, which extends in the reflecting plane. The reflector reflects the light beam towards the detection area.

The transducer also includes a linkage assembly having a first and a second end, the first end being operatively connected to the vibrating member, and the second end being operatively connected to the reflector offset the pivot axis. The linkage assembly converts the vibration of the vibrating member into a pivoting of the reflector about the pivot axis, and sweeps the light beam reflected thereby across the detection area.

Finally, a sensing and encoding assembly for sensing the light beam is provided in the detection area and producing a digital signal encoded relatively to the sweeping of this light beam. This digital signal defines the digital signal representative of the vibration of the vibrating member.

Other features and advantages of the present invention will be better understood upon reading of preferred embodiments thereof with reference to the appended drawings.

### BRIEF DESCRIPTION OF THE DRAWINGS

FIG. 1 is a perspective view a digital vibration transducer according to a first embodiment of the present invention.

FIG. 2 is a partial top view of the transducer of FIG. 1.

FIG. 3A is a front elevation of an encoder as used in the embodiment of

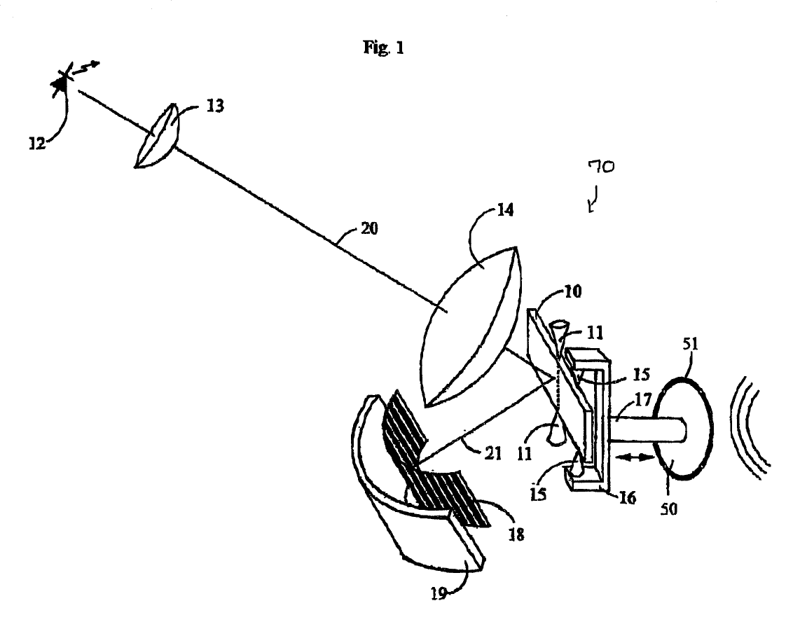

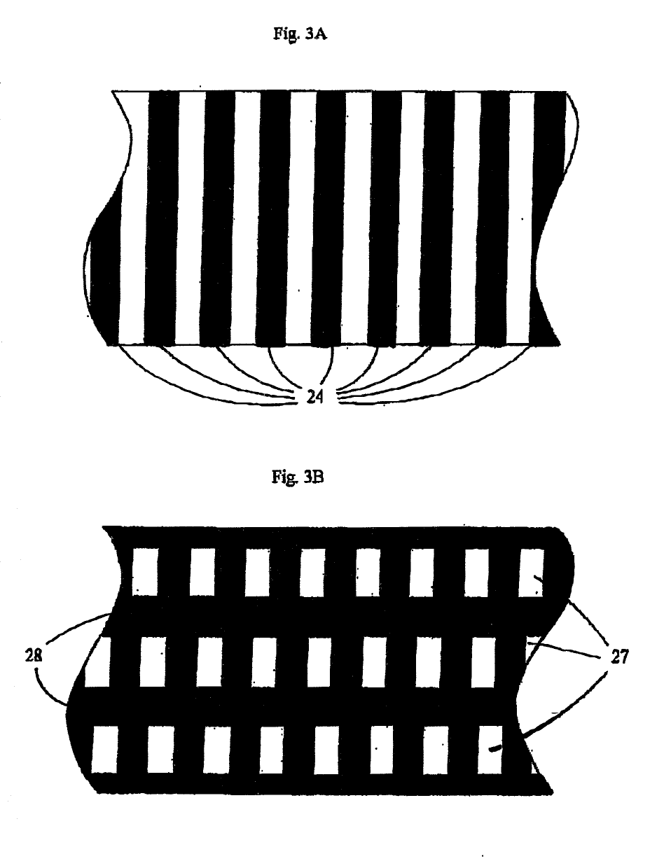

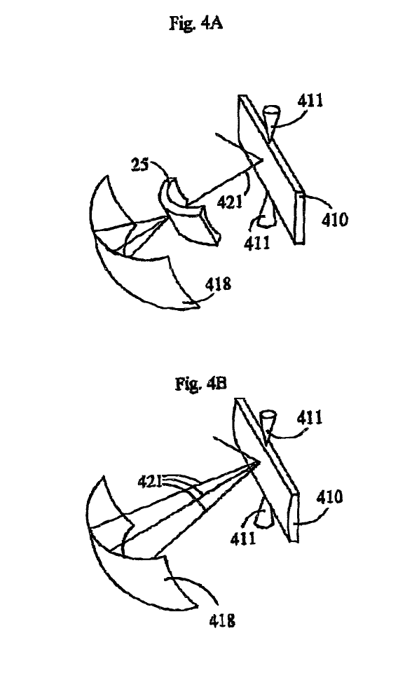

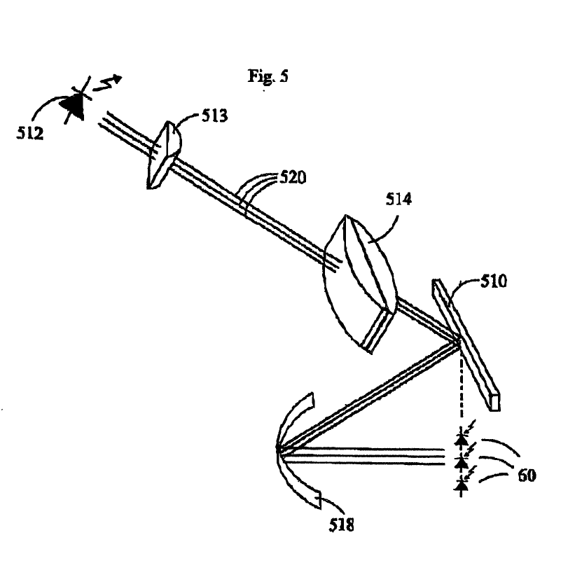

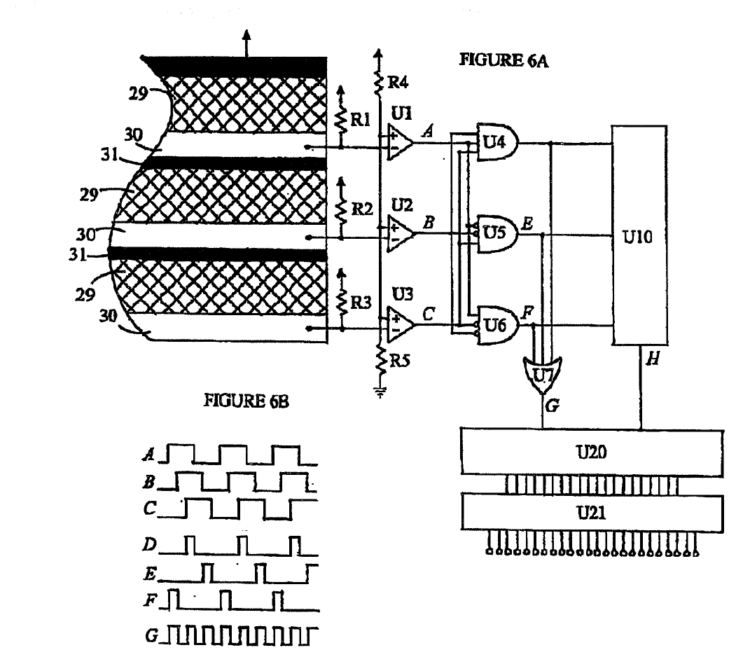

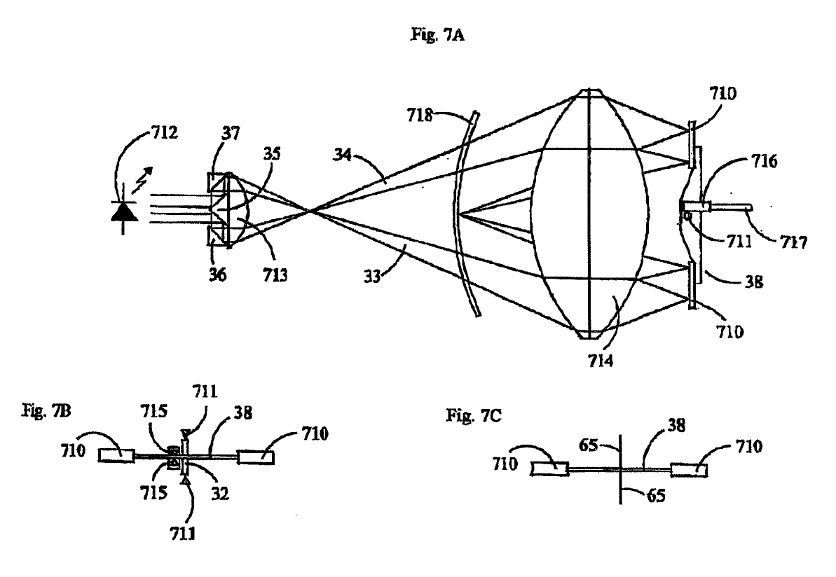

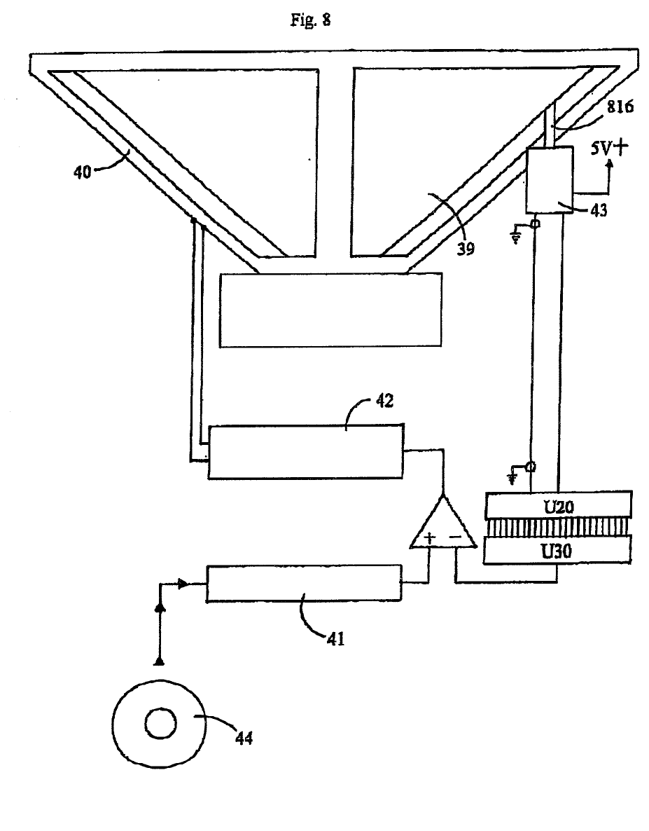

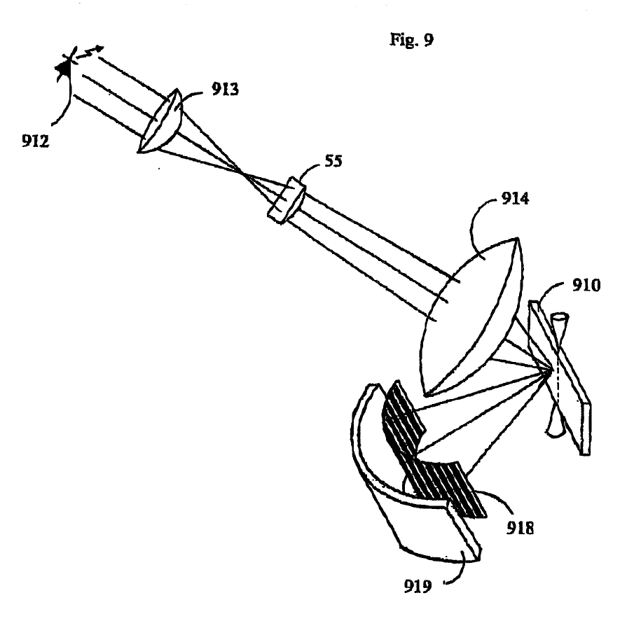

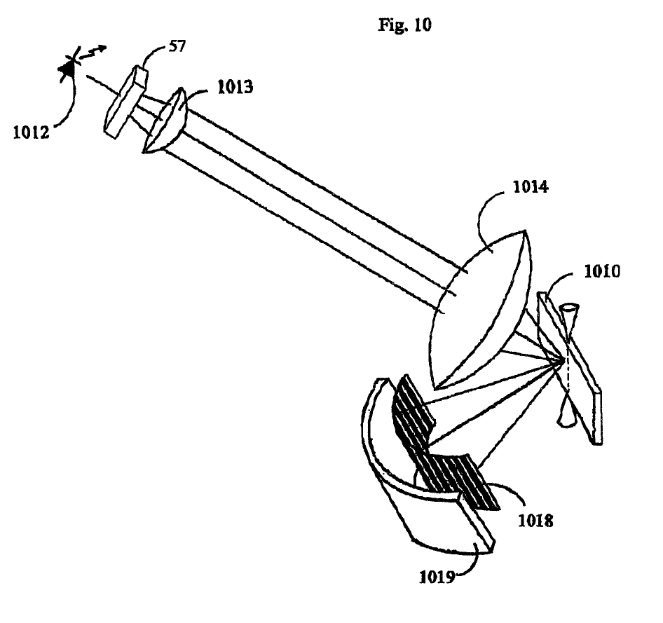

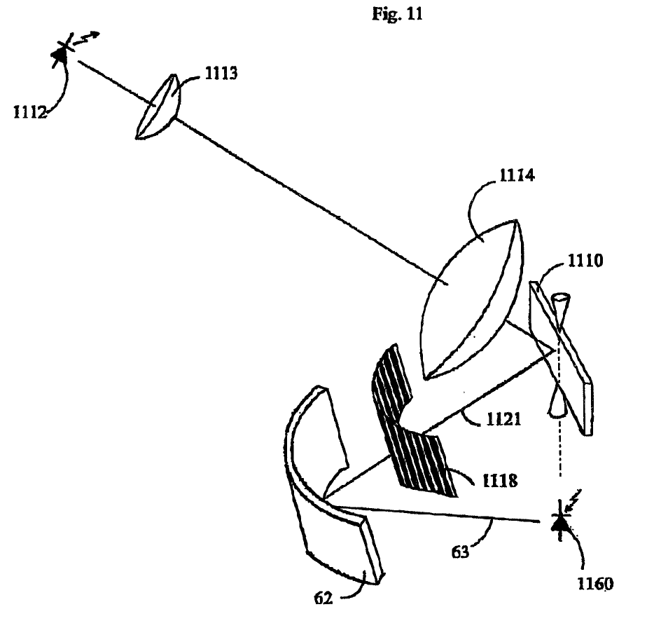

FIG. 1. FIG. 3B is a front elevation of an encoder according to an alternative embodiment of the invention.

FIG. 4A is a partial perspective view of a transducer where the light beam has a linear cross-section; FIG. 4B is an alternative embodiment to the transducer of FIG. 4A.

FIG. 5 is a partial perspective view of a transducer according to another embodiment of the invention.

FIG. 6A is a schematic representation of a light sensor and comparator circuit compatible with the encoder of FIG. 3B; FIG. 6B shows the waveform outputted at various points of FIG. 3A.

FIG. 7A is a top view of a transducer according to yet another embodiment of the invention; FIG. 7B is a partial front elevation of the reflector of the transducer of FIG. 7A; FIG. 7C is a partial view of a reflector according to a variant of the embodiment of FIG. 7B.

FIG. 8 is a schematic representation illustrating the use of a transducer according to an embodiment of the present invention in connection to a speaker.

FIGS. 9, 10 and 11 are partial perspective views of transducers according to alternative embodiments of the present invention.

### DESCRIPTION OF PREFERRED EMBODIMENTS OF THE INVENTION

The present invention takes advantage of an optical assembly to translate a mechanical motion, that is the vibration of a vibrating member, into a digital signal without any intervening analog electronic stage. The digital encoding of the motion takes place while the signal is optical in nature, and thus the limitations of analog electronics can be avoided. To this effect, there is provided a digital vibration transducer for producing a digital signal representative of the vibration movement s of the vibrating member. It is understood that the present invention may be applied to any circumstances where a vibration movement needs to be converted into a digital signal, such as for sound detection as in a microphone or speaker, for a seismograph, a hydrophone, etc.

The present invention uses a pivotable reflector whose pivoting is mechanically linked to the motion to be detected. The pivoting of this reflector optically levers a focused laser beam incident upon it, causing that laser beam to sweep across a digital encoding light motion sensor positioned at the focus point of the laser. The digitally encoding sensor operates by converting the movement of the levered light into electrical pulses, the number of which corresponds to the amount of movement of the levered light.

Generally, the present invention provides a digital vibration transducer for producing a digital signal representative of a vibration of a vibrating member.

The transducer includes a laser light source for generating a light beam having an optical axis, and focusing means for focusing this light beam on a detection area. A reflector is disposed across the light beam and defines a reflecting plane at an angle from the optical axis. The reflector is pivotable with respect to a pivot axis, which extends in this reflecting plane. The reflector reflects the light beam towards the detection area.

The transducer also includes a linkage assembly having a first and a second end, the first end being operatively connected to the vibrating member, and the second end being operatively connected to the reflector offset the pivot axis. The linkage assembly converts the vibration of the vibrating member into a pivoting of the reflector about the pivot axis, and sweeps the light beam reflected thereby across the detection area.

Finally, a sensing and encoding assembly for sensing the light beam is provided in the detection area and producing a digital signal encoded relatively to the sweeping of this light beam. This digital signal defines the digital signal representative of the vibration of the vibrating member.

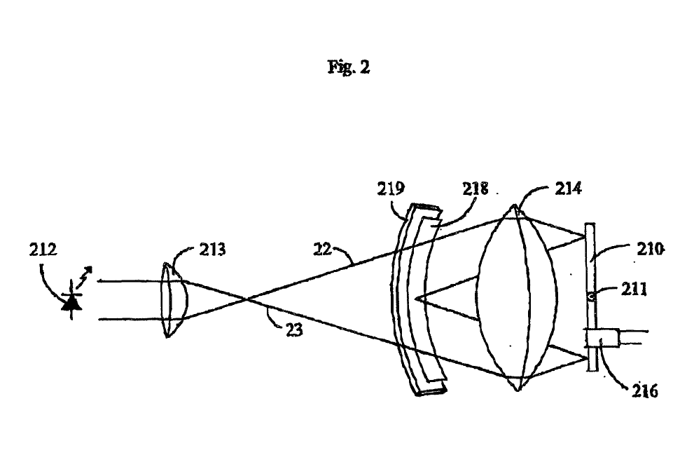

Referring to FIGS. 1 and 2, there is shown a transducer (70) according to a first embodiment of the present invention. In this particular case, the reflector is embodied by a surface mirror (10) made pivotable through suspension between two “vee” bearings (11). These bearings are aligned to allow pivoting of the mirror about a vertical pivot axis, which is preferably horizontally centered on the mirror. The bearings are preferably held in position by a stationary frame (not shown) firmly mounted to a housing (not shown) which also holds all other non-dynamic components of the system in fixed positions. The frame is presumed to cause the bearings to exert a light pressure on the mirror (10). Since it is desirable, for optimum response and sensitivity, to have as little friction and end play as possible, it is preferable to use high precision jeweled bearings. To assist visualization it may be presumed that tiny holes are provided in the edges of the mirror into which the points of the bearings are seated. For an application such as a microphone, it is further desirable that the mirror has as low a mass as possible without sacrificing stiffness and optical flatness. A thin Pyrex optical glass, vacuum deposited with a reflective metal such as aluminum or gold is one possibility.

In this embodiment, the laser light source is preferably embodied by a collimated solid-state diode laser (12) operating in its primary mode. It is presumed that diode (12) includes any lenses required to collimate its output. The light beam generated by the diode (12) is directed to the mirror (10) after passing through re-collimating and focusing optics (13 and 14), defining the focusing means for this embodiment. The first lens (13) will be called the dispersing lens, the second lens (14), which is taken to be both the final element of the re-collimator and the focusing objective, will be called the objective, and the system of the two lenses together will be called the focusing re-collimator. The focal lengths of the optics are such that the laser beam is focused on a spot some distance after reflecting off of the mirror (10). In FIG. 1, only the path of the center most light ray (20) of the laser is shown, and this ray also represents the optical axis (20) of the light beam. In FIG. 2, only the side most light rays (22 and 23) are shown so as to illustrate the refraction effects of the focusing re-collimator, and the focalisation occurring at the detection plane. Preferably, the orientation of the optics is such that the optical axis (20) of the focusing re-collimator (13 and 14) intersects with the mirrors pivot axis (dot-dash line in FIG. 1) at all times. Further, the orientation is such that, when at rest (no vibrational input to the device), the reflecting surface of the mirror is perpendicular to the focusing re-collimator's axis in the horizontal plane, that is, when viewed from above (as in FIG. 2). Thus, when the mirror is at rest, the angle of azimuth between the optical axis of the incoming light beam (20) and its reflection (21) is zero. The angle of declination between these two beams (20 and 21) is what ever will be necessary to prevent the components of the device from optically or mechanically obstructing each other.

Still referring to FIGS. 1 and 2, the linkage assembly preferably includes two linkage bearings (15) located at opposite edges of the mirror (10) some distance horizontally offset from the pivot axis. As for the previous vee bearings, tiny holes are preferably provided in the mirror's edges to receive the extremities of the linkage bearings. The axis of the linkage bearings preferably has the same vertical orientation as the pivot axis of the mirror and the smaller the distance between the two axes, the greater will be the opto-mechanical gain achieved by the device. The linkage bearings are held in place by the linkage-bearing frame (16). The frame is presumed to spring load the bearings so as to maintain a light bearing pressure upon the mirror. Attached to this frame is a linkage arm (17). The linkage arm will be as long as is needed to prevent the mirror from touching the vibration source when the mirror is pivoting. The linkage arm can be a thin paper or other lightweight tube so that it will have high stiffness, low mass and little resonance. To the other end of this linkage arm is attached the vibration source (50), in this case, a microphone diaphragm held inside a frame (51), though it could be a speaker cone, a seismographic source, hydrophonic source etc. Whatever the vibration source, the attachment is best made so that, when no vibrations are present, the linkage arm (17) is at a right angle to a line drawn between the mirror's pivot axis and the linkage bearing axis, and perpendicular to the mirror's pivot axis. Further, the orientation of all components is preferably such that the vibrational source moves the linkage arm (17) along its longitudinal direction (shown by the arrow of FIG. 1). Thus, for example in the case of a microphone diaphragm, sound vibrations are transferred to the linkage arm, via the diaphragm (50), which causes the mirror to pivot cyclically about the pivot axis, which in turn levers (in the manner of a third class lever) the laser light to sweep an arc along the focal plane. The circle of this focal plane arc has the mirror axis as its center. The opto-mechanical gain of this arrangement is approximately the radius of this circle divided by the distance between the mirror axis and the linkage-bearing axis.

Along the arc of the focal plane is disposed the sensing and encoding assembly. In the present embodiment, this assembly includes a digital encoding plate (18) and a light sensor (19). The light sensor (19) may be a silicon cell, which outputs a current proportional to the light it receives. Referring the FIGS. 1, 2, and 3A, the encoding plate (18) is preferably composed of opaque vertical stripes or “pickets” (24) horizontally equidistant and of the same width as the light transmissive spaces between them. FIG. 3A shows a section of the encoding plate, as it might appear greatly magnified and viewed face on. In FIG. 1, to assist visualization, the pickets are shown as dark vertical stripes, having considerable width, on the encoding plate (18). In practice, the pickets would preferably be so narrow (about 1 micron) as to be invisible to the unaided eye. The width of a picket (24) is referred to as the “pitch”. The pitch is selected to closely match the spot size of the focused laser so that as the mirror (10) levers the laser spot to sweep across the encoding plate (18), the light is alternately blocked and allowed to pass through the encoding plate to the light sensor (19) behind it. The light sensor (19) consequently outputs square (or square-like) wave pulses in an amount that corresponds to the distance that the laser spot has moved. A binary counter then counts these pulses and outputs a continually updating binary number that indicates the position of the laser spot in a typical parallel digital format. The resolution to which this movement is measured is, therefore, determined by the encoder's pitch and the laser's focused spot size on which it depends. Thus, the smaller the laser spot size and encoder pitch, the higher the resolution.

The smallest size to which a laser can be focused depends on the wavelength of the laser (12) and the numerical aperture (NA) of the objective lens (14). The spot size cannot be smaller than the wavelength of the laser's monochromatic light, and in the interests of cost and overall size of the device it is preferable in these embodiments to use a typical solid-state diode laser. These, with present technology, most commonly operate in the red end of the spectrum and, although a reliable solid-state blue laser has recently been developed and may prove an effective alternative, the descriptions in this section will assume a red laser of 0.63 microns wavelength. It is however understood that any other type of laser source appropriate for a given application of the present device would still be encompassed within the scope of the present invention. Present technology also routinely manufactures media (such as compact discs, or CDs) having a 1 micron pitch and, so, this will be taken as a realistic pitch for the digital encoding plate, and indeed, typical CD creation methods might also be adapted to create encoding plates. The numerical aperture of an optical system is defined as the product of the refraction index (in this case 1, for air) and the sine of the angle between the optical axis and the outermost light ray contributing to the imaging. Due to diffraction at the lens aperture, however, the laser “spot” does not have a sharp edge and is, instead, a spot brightest at its center, fading towards the edge and having around it annuli of decreasing brightness. If the spot diameter is taken as the half-intensity diameter, it is found that for NA =0.36 and a wavelength of 0.63 microns, the (half-intensity) spot diameter is 1 micron. This corresponds to an objective lens diameter that is 0.77 times the distance of the lens to the focus point, and the relationship is such that the wider the lens is, compared to the focus distance, the smaller the spot will be. Since the length of the optical lever arm is the distance from the mirror to the focus point it is, more importantly, the mirror that will need a NA of 0.36 to produce a spot of a diameter of 1 micron. The objective lens will be wider than the mirror in order to illuminate it near fully. Thus, for a spot size of 1 micron, the mirror width will be 0.77 of its distance from the focus or encoding plate. However, since the mirror will be deviating from its rest position by up to, perhaps, 10 degrees, its apparent width, relative to the focusing re-collimator's axis, will be correspondingly reduced the greater that deviation is. Thus, the effective width of the mirror at maximum deviation will be equal to the cosine of the deviation angle times the actual width, or 0.985 times actual width for 10 degrees. So, for a mirror that may pivot 10 degrees, its width should actually be about 0.78 times its distance to the encoding plate in order to sustain a 1 micron spot diameter throughout its deviation. This change of effective width when the mirror pivots also requires the mirror to be wider than the illuminating beam if it is desired for the reflection to maintain a constant intensity. Conversely, there may be some advantage in having the illuminating beam wider than the mirror, as that may eliminate some aperture diffraction from the reflected light. It should be further noted, though, that it is not actually necessary for the laser spot to be circular, with a small diameter, and it will suffice if the laser spot is merely narrow in width. Since the orientation of the pickets is vertical, any vertical elongation of the laser at the focus will be irrelevant as long as the elongation is not so much that it causes excessive laser light to be lost by spilling past the encoding sensor altogether. Consequently, it is also found that the height of the mirror is not a contributing factor in causing the laser to have narrow width at focus and, rather, it is only the width of the mirror that is essential. Even further, it has been found that the center of the mirror and the central rays of the optics are not essential for producing a laser focus of narrow width, and, instead, only the outer edges of the mirror and the outermost rays (in the horizontal dimension) are needed to provide the desired focus.

If the application of the device is for detection of vibrations having simple waveforms and large power, the above embodiment would be adequate, and the dimensions and mass of the mirror would not be of the utmost concern. If the input waveforms are square waves or sine waves of a single frequency, the circuitry to which the output of the encoding sensor is attached could easily distinguish one direction of spot movement from the other (since the sensor itself, as described above, does not indicated the direction of movement, only the amount). With such waveforms the spot would stop moving before it changes direction and a logic circuit could use the lack of pulses output at that time as a condition for switching the binary counter from up to down, or vice versa. If, however, the application of the device is for detection of complex waveforms (such as sound) whose amplitudes may also be relatively weak, a more sensible setup might be preferable.

Referring to FIGS. 4A, 4B and 5, there are shown several alternative embodiments of the present invention where the laser “spot” is vertically elongated while remaining horizontally narrow, thereby defining a generally linear cross-section. The advantages of such embodiments will be explained further below. There are a number of ways to achieve this elongation, which vary in practicality. In FIG. 4A, a cylindrical lens of concave profile (25) is placed between the mirror (410) and the encoding plate (418), and causes the reflected laser light (21) to disperse vertically while remaining unaffected horizontally. It is also best if this lens (25) is curved in an arc that has the mirror's pivot axis as its center. FIG. 4B shows a second, more practical method of achieving this result where the mirror (410) itself has a vertical curvature. This causes a vertical dispersal of the reflected laser light (21) while leaving it horizontally unaffected. FIG. 5 shows a third, and still more practical, setup where the focusing re-collimator's optics includes cylindrical lenses (513 and 514) which are horizontally curved but have no vertical curvature. By way of example, in FIG. 5 the objective (514) is shown as composed of two piano-convex cylindrical lenses glued together. Thus, focusing occurs only in the horizontal plane and the laser beam (26), being unaffected vertically, arrives at the mirror with its raw collimated height (FIG. 5 shows only a vertical slice of the laser light, 26, that includes the center, top and bottom most rays). Laser diodes typically emit an elliptical beam having dimensions of about 1 by 4 mm. It is assumed that the laser diode includes any collimating lens that is necessary to output the typical beam. If the diode is oriented to have its shorter beam dimension (1 mm) vertical it will retain that height, after passing through the cylindrical lenses (513 and 514), upon striking the mirror (510), and if the mirror (510) is also about 1 mm high the reflected beam will then strike the encoding plate (518) retaining this 1 mm of height while having been focused horizontally down to a very narrow width. This 1 mm of vertical height will be sufficient for the second encoder embodiment described further below. Alternatively, it is also possible, though possibly more expensive, to use a cylindrically concave mirror as the reflector, so it can act as the as the objective (514) of the focussing means as well as the optical lever (510), and thus eliminate the lens (514). This approach could become cost effective if the mirror (510) can be made from plastic. A plastic mirror, however, would probably limit the device to the lesser demanding applications.

Referring to FIG. 9, there is shown yet another embodiment where the light beam striking the sensing and encoding assembly is given a linear cross-section. In this case, a cylindrical lens is used to cause a vertical elongation at the encoding plate. This method retains the optics illustrated in FIG. 1 while adding a cylindrical lens (55) between the dispersing lens (913) and the objective lens (914). This cylindrical lens (55) has no significant horizontal effect on light rays, which, therefore, will retain the pathways illustrated in FIG. 2. Instead, this lens (55) causes the light to vertically focus at the mirror (910) and then vertically spread to cause the desired elongation at the encoding plate. This method has the advantage of allowing for a mirror of very narrow height. It also represents bi-toric optics having astigmatic properties.

Referring to FIG. 10, there is shown still another method that can be used for producing an effect similar to vertical elongation. In this embodiment, a diffraction grating (57) is placed in the path of the collimated output of the laser diode (1012). This causes a vertical breakup of the light into multiple vertical spots at the encoding plate (1018), while having no horizontal effect on the light. These vertical elongation methods are intended to provide the illumination required for the encoding plate described in the following embodiment.

It is understood that the various embodiments described above are not an exhaustive list of methods of generating a light beam having a linear cross-section, and that any other appropriate manner of achieving the same result is considered as encompassed within the scope of the present invention.

Referring to FIGS. 3B, 6A and 6B, there is shown an example of a sensing and encoding assembly which may be used jointly with any of the embodiments above or others where the light beam has been given a linear cross-section. As shown in FIG. 3B, the encoder preferably includes a plurality of independent encoding bands (27), three in the illustrated case, each provided with dark and clear stripes as explained above, stacked vertically adjacent to each other on the encoding plate. Each encoding band is separated from its neighbor by an opaque horizontal stripe (28). This horizontal stripe serves to minimize light that has been modulated by one encoding band (27) from spilling onto the light sensor dedicated to an adjacent encoding band. Preferably, an independent light sensor (29) is provided behind each encoding bands, so that for the three encoding bands (27) there are three corresponding light sensors (29), and the arrangement constitutes a vertical stack of three independent encoding sensors. In FIG. 6A the crosshatch-patterned strips (29), in the light sensor stack, represent the photosensitive sections of the stack, the clear strips (30) are the conductors for the adjacent photosensitive strips, and the black strips (31) are insulation gaps between the three independent sensors. Each encoding band (27) of FIG. 3B should be visualized as superimposed over the crosshatch strips (29) of FIG. 6A so as to constitute the vertical stack of encoding sensors. The stripes of each encoding band (27) are preferably horizontally offset from those of the adjacent encoding band by an amount equal to 1/n times the pitch (1/n×1 micron, in this case), where n equals the number of encoding bands in the stack. Because the laser is now a vertical line, preferably 1 mm by 1 micron, at the focus the full height of the stack is illuminated (the proportions in FIG. 3B represent that, for if a pitch of 1 micron is assumed, each picket would be 2 microns high, and that the combined height of this stack would be less than 9 microns). Thus, as this laser line is levered, by an input signal, horizontally across this stack the individual outputs of each encoding sensor in the stack will be pulses that are ½n of a cycle out of phase with those sensors to which it is adjacent. After these individual pulse streams are logic gated together (FIG. 6A), the resulting single output (G) will have n pulses for each micron of spot movement. This has the result of reducing the effective pitch to 1/n (⅓, for this case) of a micron. Also, for a stack of three or more encoding sensors the direction of spot motion can be readily determined by logic discrimination of the order in which the individual sensors are pulsing. Alternatively, a similar effect to the multiple offset encoding bands of FIG. 3B could be achieved by rotating the single encoding plate of FIG. 3A. That is, if this encoding plate is tilted from having its pickets (24) perfectly vertical by a small amount (i.e. 10 degrees CCW), the associated (vertically oriented) multiple photo-sensors will be illuminated sequentially as the perfectly vertical laser line sweeps across it, thus achieving the same effect as a offset stack of encoding strips. The disadvantage to this approach is that it causes the laser line to have a greater effective width, however, that may be outweighed by the economics of a simpler encoding plate, at least, in some applications.

In the embodiment of FIG. 6A, the output of each of the light sensors (29) is considered to be negative going when light strikes the sensor. The upward pointing arrows in the figure represent the positive supply voltage, for example 5 volts. The negative going pulses are inverted by comparators U1, U2 and U3 into square wave pulses A, B and C, which are illustrated on the timing chart, FIG. 6B. These waveforms are the result of the focused laser line sweeping at a steady speed from left to right across the encoding bands stack illustrated in FIG. 3B, which is assumed to be superimposed over the light sensor stack in FIG. 6A. R4 and R5 set the threshold of the comparators and R1, R2 and R3 are pull up resistors that hold the inverting inputs of the comparators positive when no light is striking the associated photosensitive strip. The outputs (A, B and C) of all three comparators are sent to three input AND gates (U4, U5 and U6). U4 has no inverting inputs and its output, waveform D, is positive when A, B and C are all positive. U5 has inputs A and B inverted and C non-inverted, so its output, waveform C, is positive when waveforms A and B are negative and C is positive. U6 has input A non-inverted and inputs B and C inverted, so its output, waveform F, is positive when A is positive, and B and C are negative. The outputs of U4, U5 and U6 (waveforms D, E and F) are gated together by U7, a three input OR gate, which consequently outputs waveform G. This output is a measurement of the amount of movement of the laser line across the encoder and has a resolution three times that of any single light sensor in the stack. The three waveforms D, E and F are also sent to direction discriminator U10, which outputs a high or a low at output H depending on the order in which D, E and F are occurring. The direction signal, H, and the waveform to be counted, G, are both sent to counter U20 which will count either up or down, depending on the level of H, and continuously output a binary number of (for this example) 20 parallel bits. This 20 bit output is then sent to calibrator U21, which adjusts the value of U20's output to compensate for any non-linearity, and outputs a corrected result of 21 parallel bits or more, depending on the degree of non-linearity.

Referring to FIG. 11, there is shown yet another embodiment of the present invention. Because a photo-sensor of an area as large as the encoding plate shown above will be “slow”, due to capacitance, it may be advantageous to focus the encoded light onto a sensor of very small dimensions, such as a photodiode (1160). While this could be done with a large lens placed behind the encoding plate, it would be far more cost effective to do this with a static curved mirror (62) that will always reflect light back in the direction of the pivot axis of the mirror (1110) where can be placed a photodiode (1160). Even simpler, the encoding plate may be reflective. In this case the transmissive spaces between the pickets of the encoder can be considered, instead of transparent, as reflective, and the encoder is then angled to reflect the modulated light to a plurality of photodiodes (60) under the rotatable mirror, as illustrated in FIG. 5. The output of these photodiodes would then become the input to the circuitry appearing in FIG. 6A, already described above.

It is also possible to reflect light towards the pivotable mirror itself, back along the original path of the optics, and try to retrieve the encoded signal using a beam splitter (as in the manner used by a CD reading head). However, the astigmatic properties of the already suggested optics would make this approach more difficult than placing the photodiodes on a independent optical pathway.

A further possibility is to embody the sensing and encoding assembly as a photosensitive array itself, such as a CCD (Charge Coupled Device). In this case the transmissive spaces (27) of FIG. 3B would represent the “pixels” (picture elements) of the array, and an adaptation of typical CCD circuitry would derive the necessary digital signals.

Referring to FIGS. 7A, 7B and 7C, there are shown variants of yet another embodiment of the present invention which would be advantageous for applications requiring very high sensitivity. Here the reflector is composed of two end mirrors (710). That is, the center section of the mirror is cut out and replaced by a frame member (38) of lighter material (such as graphite composite or titanium composite) that holds the two end mirrors in the same plane as if they were one continuous mirror. This arrangement also allows these end mirrors (710) to be thinner, front to back, since they don't have as much length needing to be sustained optically flat. This arrangement is consequently much lighter than the solid mirror version and is, likewise, that much more sensitive.

Since in this embodiment the central portion of the reflector is not made of glass, this embodiment also makes it easier to inlay a jewel piece (not shown) into the frame member (38) for the linkage bearings (715) to be mated to, so that both the top and bottom bearings of the linkage (715) are jewel to jewel. Likewise, the pivot axis bearings (711) can be applied to a jewel rod (32) passing through the frame member (38) so those top and bottom matings are also jewel-to-jewel and thus, within tolerance, the lifetime of all of the bearings will be greatly improved. While it is also possible to inlay a single jewel sleeve bearing and pivot this section about a shaft, it is believed that the above “vee”, or conical, shaped bearings will give a finer tolerance. FIG. 7C shows, also, a wire suspension (65) “bearing” being used to permit the mirror (710) to rotate. Unfortunately, besides not having the lowest resistance, the very flexibility of the wire that allows it to rotate can also allow undesired movement, such as lateral movement, or wobbling. Thus the use of a wire suspension would be limited to the least sensitive applications of the DVT.

In this latest embodiment, to make the most effective use of the laser light, in this case, it is preferable to concentrate the laser light into two beams (33 and 34), of 1 mm height, as they leave the diverging lens (713) so that they strike only at the edges of the cylindrical objective lens (714). Thus, no light is wasted on the center of that lens (714), since it would be useless with the center-less reflector (710). This further implies that “cylindrical” aberration (the cylindrical equivalent of spherical aberration) is of lesser concern so that, in many cases, a simple cylindrical lens will likely suffice, and an acylindric (the cylindrical equivalent of aspheric) lens will not be needed. In order to cause this desired splitting of the light beam a beamsplitter is provided, which may simply be embodied by a plano-convex cylindrical lens (13) having a flat side facing the laser on which are glued three small prisms (35, 36 and 37). In FIG. 7A, for clarity, the prisms (35, 36 and 37) are shown reflecting light from their external surfaces (as if they were silvered, for example), and it is obvious that it would be impractical to glue the outermost prisms (36 and 37) in that orientation. In practice, the outer prisms (36 and 37) may be reoriented to have their reflections from an interior surface, and in that orientation they could easily be glued to the dispersing lens (13). The orientation of the prisms, either way, is such that the laser is split and the two halves of the laser light are redirected to the outer edges of the piano-convex dispersing lens (713) as shown in FIG. 7A. Here, again, “cylindrical” aberration becomes of lesser concern for this lens (713) since only its edges are being used. FIG. 7A shows the resulting pathways for four of the light rays (two inner and two outer) in this optical arrangement (the pathway of these rays passing through lens 714 are shown as solid lines and the pathway of these rays passing under 714 are not shown) and it can be seen that most of the laser light is utilized.

FIG. 8 shows an example of application of a Digital Vibration Transducer (DVT) which is used to digitize, and remove distortion from, a speaker. Since speakers have high power, sensitivity will not be the prime requirement of a DVT used in this application. In FIG. 8 the linkage arm (816) of the DVT (shown as the enclosed unit, 43) is attached to the rear of the speaker cone (39) while the enclosure of the DVT (43) is firmly attached to the speaker frame (40). The attachment is made so that when the speaker cone (39) is at rest the rotational mirror will also be at its rest position (0 angle of deviation). At this point there are a number of different ways to proceed. The DVT's output could be digitally compared with the digital signal of the source device (44), if that device were a CD player, for example. One skilled in the art will easily think of other configurations, however, only the following configuration will be described since it is the most practical and versatile for the arrangement of most existing sound systems. In this configuration, the output of the DVT's binary counter (U20) is first converted to analog by a DAC (Digital to Analog Converter), U30, and this analog signal is compared by comparator U31 with the analog signal coming from the pre-amp (41) of the sound system. Any discrepancy between the pre-amp signal and the DVT's analog signal from the speaker causes a correction signal. This correction signal now becomes the input to the power amp (42) in place of the pre-amp signal that was originally connected to the power amp input. Provided that the power amp (42) has good damping and phase reproduction, the result of this configuration is that the speaker excursions will, virtually, perfectly match the signal leaving the system's pre-amp and any distortions introduced after, by the speaker, for example, will be removed by the feedback loop. In this configuration it may be desirable to remotely locate the DVT's counter (U20) with the DAC (U30) and comparator (U31) so that only a coaxial cable need run from the speaker (carrying waveform G), along with one line to power the DVT if it is not using power from the power amp signal accessible within the speaker, and one line to carry the direction signal (H) to the counter (U20). Again, while other configurations for this DVT feedback system are possible. the intended end result for all of them is the same, removal of distortion from the speaker.

The digital vibration transducer of the present invention offers many potential advantages on prior art transducers, especially of the analog type.

The (DVT) can be used to construct a microphone with an instantaneous dynamic range of more than 120 dB. The dynamic range of a digital device is determined by the number of bits utilized or quantization level. Thus, for a compact disc, which uses 16 bit quantization, the dynamic range is 96 dB, which corresponds to a 65,536 fold difference in volume. The addition of another bit to make a 17 bit quantization device would double that range to 102 dB or 131,072 fold. At 18 bits quantization the dynamic range is 108 dB or 262,144 fold, at 20 bits the dynamic range is 120 dB or 1,048,576 fold, and at 22 bits the range is 132 dB or 4,194,304 fold. At 24 bits (the present standard for professional mixing) the dynamic range is 144 dB or 16,777,216 fold.

While there is no absolute limit to the maximum quantization level possible for the digital vibration transducer, the ideal level varies with the application. When the vibration source is vocal sound, particularly vocal music, and the application is as a microphone such as a hand held or headset mounted microphone, and a high sensitivity is desired, it is necessary for most parts of the device to be as small and light as practical. A quantization level of 20 bits would appear to be best for constructing a DVT microphone having dimensions somewhat smaller than a C cell battery, light overall weight, and high sensitivity. Such a microphone would have a minimum 120 dB dynamic range and since this would be the instantaneous dynamic range, such a microphone detecting a sound of 120 dB would theoretically also be capable of detecting a sound of 0 dB at the same time. In practice, however, it would be desirable for such a microphone, if intended for loud environments, to have some “headroom” and be able to withstand a sound pressure level (SPL) of 140 dB. Also, the first 20 dB above the detection threshold of such a microphone can have distortion over 5%. It is, therefore, more realistic to say that the usable dynamic range of such a microphone would be, at least, 100 dB and that in a loud environment, if so adjusted, it would be capable of faithfully capturing sounds in the range of 40 dB to 140 dB simultaneously. Since normal conversation is considered to be at 74 dB, someone speaking in a normal voice a few feet from this microphone, in a loud environment, would be detected, and what was said could be extracted from a digital recording, even though a person standing right next to the one speaking wouldn't have been able to hear a word.

This extraordinary capability has implications beyond those that might be immediately apparent. Such a microphone placed in the cockpit of an aircraft, for example, or used to replace the relatively limited quality microphones on the flight officers' headsets, would allow for cockpit voice recordings that include much greater detailed and accurate sounds of the environment, and which would also be more easily processed to extract isolated sounds.

When size is of less concern the DVT can easily be constructed to provide a 24-bit quantization level. This with a sensitivity well below 0 dB and while retaining a size not larger than two D cell batteries. Such a DVT in the application of a hydrophone would be able to detect weak underwater sounds even when the props and engines of a nearby ship are also being detected and would swamp a conventional analog hydrophone.

In seismology the mass of the vibration source, that is the earth itself, is so great that the mass and size of the components in the DVT becomes of lesser concern and quantization levels over 24 bits are easily achieved. A 24-bit quantization level corresponds to a 144 dB instantaneous dynamic range or 16,777,216 times, which is also equivalent to about 8 points of magnitude on the Richter scale. Thus, the DVT used as a seismograph could be expected to easily and accurately detect vibrations differing by 7 points of magnitude simultaneously. A typical analog seismograph, designed to continuously monitor events at around magnitude 2 is swamped by a magnitude 7 event and will lose detail of any lower magnitude vibrations happening at the same time. It is conceivable that a DVT seismograph might reveal details of the earth dynamics of which we are, as yet, unaware. Further such a device interfaces well with existing systems that record their data in a digital format, on a hard drive for example, so that continuous high resolution monitoring can be maintained. Such existing systems currently require converting analog signals from analog seismographs by means of an ADC, and have their instantaneous dynamic range thus limited to that available from the analog stage (about 40 dB or 100 times).

Another outstanding feature of the DVT is its frequency response, especially its low frequency response. Thus, while there may be an upper frequency limitation, and this limitation is dependent on the mass of certain components, there is no lower limit and frequencies as low as 0.1 Hz and lower are detectable. Depending on how the sensing membrane is vented to the atmosphere the device can be use as an extremely sensitive barometric device such as a variometer.

An important limitation of the existing art of analog sound transducers is distortion. As mentioned above, analog transducers have more distortion the higher they are in their dynamic range. Thus, the louder the sound entering a microphone or leaving a speaker, for example, the more likely it is to distort. A major source of this distortion is non-linear effects in the suspension of the sound sensing or sound invoking membrane. In order for a sound sensing or invoking membrane to have a rest position to which will go back to when there is no signal, the suspension must have an elastic, non-linear nature. That is, the farther the membrane is deviated from its rest position, the greater must be the opposing force of the suspension attempting to return it. It is well known that sound passing through a non-linear medium will suffer distortion as a result, and if the sound is composed of more than one frequency inter-modulation (IM) distortion results causing the introduction of tones not included in the original signal.

While a DVT, when used for similar applications, will also be prone to the same distortions inherent in devices using suspended membranes, the distortions can be removed by calibrative compensation. The DVT attached to a sound sensing membrane, for example, will output a number that corresponds to the exact position of the membrane. Since the non-linearity of the suspension is predictable it is possible to calculate how far off the position of the membrane is at any time as compared to where it would be were the suspension perfectly linear. Thus, by adjusting the digital vibration detector's output with a simple processor using a calibrating algorithm, or by using a PROM (programmable read only memory) to act as a calibration “chart”, virtually all distortion can be removed in the result.

The distortion that cannot be removed in this way is the distortion of quantization. When an analog signal is digitized it is chopped up into discrete levels that approximate the original signal. The accuracy of that approximation depends on the level of quantization, how many different levels the signal can be chopped into. Thus, if a signal is so weak it only just exceeds the threshold of detection, the level of quantization for that signal may be as low as one bit, one level, either on or off. The output of the device in that case can only be a square wave. If the input signal is also a square wave then there may be no distortion but if the input signal is a sine wave then we could say the distortion in that case is perhaps less than 50%. As the input level of the signal increases, however, more bits come into play and once the signal is strong enough to activate the first 4 bits there will be 15 levels into which it can be chopped and the distortion will have dropped to around 1/15 or less than 3.3%. Thus, in contrast to analog devices, the higher or louder the input, the lower the distortion, provided the upper limit of volume is not exceeded. Each 20 dB of SPL represents a 10 fold increase of digitization, so for a signal of 20 dB above threshold, distortion is less than 5%, at 40 dB above threshold−less than 0.5%, and at 60 dB above threshold, distortion will be less 0.05%. A 22 bit DVT used as a microphone and having a dynamic range of 132 dB will, therefore, have the 92 dB of that range at a distortion of less than 0.5% and 72 dB of that range at less than 0.05% distortion. This far out performs conventional, analog, microphones only the very best of which can achieve a distortion as low as 1%.

The results are just as dramatic when the DVT is used in attachment with a speaker. In this case the DVT is attached to the speaker cone and used to measure the position of the cone in comparison to where it should be based on the signal being input to the speaker's voice coil. If there is a discrepancy between the output of the DVT and the input signal to the voice coil, a simple comparator circuit develops a correction signal, which is used to adjust the voltage on the speaker's voice coil and thus correct the errors and distortion in the cone's movement whatever their origins may be. This can be achieved with relatively simple electronics added within the speaker enclosure, and without an additional power source if the system uses and stores some of the power already being supplied to the speaker by the power amplifier. This effectively constitutes the digitization of a speaker, and the result of retrofitting even the best existing speaker models with such a system can be expected to exceed a tenfold reduction in distortion.

With respect to noise, the advantage of the DVT over that of its analog counterpart is particularly notable in its application as a microphone or hydrophone. The signal to noise ratio of a digital device is generally the same as its dynamic range or, in the case of a 20-bit device the s/n ratio will be 120 dB. An 80 dB s/n ratio would be considered outstanding for an analog microphone. In the DVT there is no stage where the signal exists as an analog electrical signal so there is no opportunity for the introduction of electrical noise. Similarly, since there are no electrical coils or analog lines of length the device is essentially immune to magnetic fields and all but the most severe electromagnetic interference. This, again, far exceeds the performance of existing analog microphones, for example.

It should also be noted that even though the DVT can be used to construct audio transducers having a many fold improvement in performance over prior technology, that does not necessarily also mean a many fold increase in cost. The cost of a microphone constructed with the DVT would be comparable to the best examples of its analog counterpart. Retrofitting a speaker for digital correction by the device could be done at percentage of the initial cost of the speaker and could, further, enable less expensive speaker to have a performance exceeding those in a higher price range.

### Technical Discussion

The various point discussed are meant as additional information for allowing one skilled in the art to better understand the embodiments described above, and are in no way considered as limitative of the scope of the invention.

Frequency Response. While the Digital Vibration Transducer (DVT) has no lower frequency limit (this is because the encoding sensor will output pulses no matter how slowly the laser sweeps across it), the upper frequency limit is almost entirely dependent on the mass of the dynamic components. As illustrated in the third embodiment, that mass can be made very low. How low that mass can become is technology dependent and can not be fixed absolutely. It is reasonable to expect that, with present technology, the device can achieve a better than 100 kHz response. The frequency range is dependent on the dynamic range of the device. This is because signals of different frequencies but the same power can vary by orders of magnitude in the amount of diaphragm excursion, and therefore, the amount of laser deflection across the encoding plate, they cause. Thus a 20 kHz signal will produce one millionth of the laser deflection that a 20 Hz signal will produce at the same power. If both these signals are within the dynamic range of the device (i.e. 1,048,576 fold for a 20 bit device) the response will be flat to within +/−3 dB, at that power level, and the greatest deviation from absolutely flat will be at the upper frequency when the least number of bits are being invoked. Thus, for a 20 bit device intended to start responding at 20 Hz, the response curve will be flat until the graph approaches 20 kHz where it will curve exponentially to +/−3 dB at 20 kHz. The response curve for a 22 bit device will have the same shape, but with the range going from 20 Hz to 80 kHz, and for a 24 bit device that curve will have a range from 20 Hz to 320 kHz. These response curves are characteristic of all digital devices responding to a flat signal source, and they are in contrast to those one would get from analog devices, particularly of the moving coil type. Analog moving coil detectors such as dynamic microphones and magnetic phono cartridges are “velocity sensitive” and for a given coil excursion will produce a higher output voltage the higher the frequency. As a result such devices tend to perform more poorly at low frequencies and suffer low frequency limitations.

The limitations of the DVT, if it is receiving its vibrations from a perfectly suspended membrane, is that a large part of its dynamic range is being used to capture the extreme variation of excursion caused by the top and bottom frequencies (when they have equivalent power), and this leaves less dynamic range left over to capture variations in power throughout that frequency range. This can be solved by using a sound sensing membrane that is not perfectly suspended but is, rather, considerably non-linear. Since the non-linearity can be removed from the output (by digital calibration) distortions from such a membrane will not be a concern and, instead, advantage can be taken from the dynamic compressive effects of a membrane so suspended. That is, a membrane suspension can be used that has little resistance to small excursions but has considerable resistance to large excursions, and thus, amplitude compression takes place at the sound sensing component itself. This then, after decompression by the calibration circuitry, results in a signal having a several fold increase in dynamic range over that available from the encoding sensor itself. This configuration would be optimal when the application is for detecting the wide frequency range that occurs with music.

When the DVT is used to digitize a speaker, one is invariably dealing with speakers dedicated to a narrower range of the musical frequency spectrum (i.e. woofers, tweeters etc.), and since separate DVTs may be attached to each speaker, the same full spectrum concern of the above application does not apply. Similarly, when the application is primarily concerned with detecting large amplitude variations (seismology, for example) one generally finds the frequency range of such signals to be much narrower than that demanded by music. Ultimately, then, it is found that the most fundamental parameters, which set all the other performance characteristics and limitations for the DVT, are sensitivity and dynamic range.

Sensitivity. High sensitivity is a quality desired when the DVT is used for detecting weak signals such as in the application of a sensitive microphone or hydrophone. The three factors most influencing the sensitivity of the digital vibration transducer are:

the mass of the mirror component with the linkage arm and its bearings,

the opto-mechanical gain of the levering arm,

the effective pitch of the encoder and the laser wavelength on which the pitch depends.

The effective pitch of the encoder depends first on the actual pitch of a single encoding band and this is limited to about 0.5 microns if a blue (440 nm) solid state laser is used. The effective pitch then depends on the maximum number of encoding bands that can be in the stack, and while the maximum possible number has yet to be established, a stack of 100 levels, giving an effective pitch of 5 nm, with a blue laser, appears to be within the limits of feasibility.

The opto-mechanical gain of the arrangement depends on the distance between the linkage bearing axis and the mirror's pivot axis as compared with the distance from the mirror axis to the laser focus point. While this relationship might appear to allow for very large values of gain, in practice, it is desirable to keep the opto-mechanical gain as low as practical since its value also multiplies the mass of the mirror in terms of rotational inertia (due to the dynamics of a class three lever) and so, any increasing of opto-mechanical gain would be of limited value if not accompanied by a corresponding reduction in the mass of the mirror. For this discussion a gain of about 50 seems practical for use with a very light mirror arranged as in the third embodiment, when the objective is for optimum sensitivity.

While it is difficult to establish an absolute limit to how low the mass of the mirror assembly and linkage can be made, measurements show that, in the configuration of the third embodiment, and using an opto-mechanical gain of 50, an inertia of less than 0.1 grams can be readily achieved, and this even with including the mass of a diaphragm (without the weight of a copper coil a diaphragm can be extremely light). Such an inertia in combination with an effective encoder pitch of 5 nm, and the 50 times opto-mechanical gain suggested (giving a resolution to 0.1 nm of movement along the linkage arm), would be sensitive to a force of 0.00002 dynes-cm². Using a 1-cm² diaphragm this would correspond to a sensitivity of −20 dB or lower, depending on the frequency. While this is an extremely high sensitivity, it can be higher still by just using a larger diaphragm. 0 dB is generally considered to be the limit of detectability for human hearing and microphones.

Dynamic range. The dynamic range is dependent of the number of bits utilized or quantization level, so that for 20 bits the range is 120 dB, for 22 bits the range is 132 dB and for 24 bits the range is 144 dB. The maximum number of bits possible is dependent on the effective encoder pitch and the length of the optical lever arm, that is, the smaller the effective pitch, the larger the number of pickets that can fit into the arc along which the mirror can sweep the laser line, and the longer the lever arm (radius) the longer will be the arc of the sweep. In the example of the third embodiment, a quantization level of at least 24 bits can be easily achieved if the encoder stack consists of enough levels. Further, the overall dynamic range is extended if a non-linear, dynamically compressive, diaphragm is used, or if a non-linear resistance is introduced anywhere among the dynamic parts of the DVT. This, however, would not increase the instantaneous dynamic range, which will remain around the level available from the encoding sensor itself.

Distortion. As outlined above, distortion can be brought to exceptionally low values, well below 1%, and particularly when calibration circuitry is applied to the output of the binary counter to compensate for any non-linearities in the system. If this circuitry is, further, designed to operate in real time there will be no sampling rate, and thus, sampling distortions will not be introduced. That is, since a CD samples at 44.1 kHz, for example, the original analog signal has to be chopped not only vertically (in amplitude) by quantization, but also horizontally (in time) by sampling. So a 5 kHz signal on a CD, for example, will be chopped about 9 times, and thus, the vertical wave shape of one such cycle will be approximated by no more than 9 discrete levels of amplitude. This constitutes a considerable amount of distortion to which the real time output of the DVT will not be subject. To achieve this real time transducing (not counting the inconsequential <1 microsecond circuit delay), meaning that the DVT's output changes every moment the laser passes a picket, it is necessary for the DVT's binary counter to be able to count at very high frequencies (VHF), and in the most demanding of applications, perhaps at ultra high frequencies (UHF). Thus, if a sine wave at 10 Hz were to cause near maximum excursion on a 24 bit DVT the pulses to the counter would be arriving at about 260 MHz. Since higher signal frequencies cause exponentially smaller excursions the fastest pulse rate will occur at the lowest signal frequencies, and so for a 300 MHz counter (well within current technology) real time instantaneous “sampling”, requiring no clock, is achieved. The end result is that all the types of distortion figures for the DVT will be orders of magnitude better than those of prior transducer art.

Noise. The signal to noise ratio (s/n) of a digital device is generally considered as equal to its dynamic range. This is to allow for the possibility of there being an error of the smallest bit. For example, if the laser line were at rest, and on the exact edge of a picket so that the sensor behind was on the exact threshold of either on or off, even thermal variation in the sensor could be the deciding factor between a one or a zero. The dynamic range, however, is so great that, for all intents and purposes, noise can be considered as nonexistent, and is, at any rate, far inferior to that encountered by any analog counterpart.

Gain. The gain of the DVT is essentially a function of the opto-mechanical gain of the levering arrangement. This can be made adjustable by the introduction of a means to make the distance between the linkage bearing axis and the mirror's pivot axis variable. Also, the addition of another lever intervening between the linkage arm and the vibration source, and having an adjustable axis point, would allow for adjustable gain. Both of these methods, however, require the addition of components to the dynamic portion of the DVT, and their added weight will increase the inertia of the system, thereby reducing sensitivity. When sensitivity is not the prime concern, such as with vocal microphones detecting well above 0 dB, such adjustability options are acceptable and often desirable. When the utmost sensitivity is required, such as with a hydrophone, a 24 bit non-adjustable version would be required. Since such a DVT can have a range of −20 to 124 dB there should be no problem. If a wider range of loudness is expected then two DVTs can be used to cover that range, such as one covering −30 to 114 dB and one covering 30 to 174 dB.

Resolution. The resolution is the smallest amount of movement detectable and is found by dividing the effective pitch by the opto-mechanical gain. When sensitivity and size is not the prime concern, very high resolution (below 0.1 nm) is easily possible as it is simply a matter of increasing the opto-mechanical gain. If the vibration source has considerable power but extremely small motion the DVT needs only to be configured having a high opto-mechanical gain and the smallest effective encoder pitch as is practical. If a 100 level encoder stack is used with a blue laser to give 5 nm effective pitch it is necessary for the laser to have enough power to be spread over the 100 levels, and still be bright enough on each individual encoding band to effectively illuminate it. Such lasers, with their heat sinks, can have sizes approaching that of an AA cell battery. The opto-mechanical gain can be increased many fold by adding another lever intervening between the linkage arm and the vibration source, further adding some additional size to the DVT. Thus, the main collateral effects of increasing resolution are an increase in size and power consumption.

Size and weight. Small size and weight are mostly needed in the application of hand held or headset mounted microphones. Since these are vocal microphones, and the source is very close, high resolution and sensitivity are not the primary objectives. Thus, a 20 bit DVT constructed to have its dynamic range (at the encoding sensor) from 10 to 130 dB, and using a non-linear suspension to extend that range to about 150 dB, would be the optimum choice. By using a 50 level encoder stack, and a small red laser, the effective encoder pitch would be 20 nm, and this would require an encoding sensor having a 2.1 cm long arc. Using this with a mirror having a 2.5 cm radius to the focal point, locating the counting and calibrating circuitry remotely, and by folding the optical pathways with static mirrors so as to economize the use of space, the transducing component could be expected to fit inside a cylinder 4 cm long by 2.5 cm wide, or somewhat shorter than a C cell battery. Further, if composite materials and acrylic optics are used, the weight of this example could be expected to be under one or two ounces. Robustness and longevity. While some of the components of the DVT have the delicacy of watch works, this actually serves to make the device as robust as a watch. That is, since the pivoting mirror can weigh less than 0.01 g, it only requires a bearing pressure of one gram to prevent the mirror from dislodging under a shock of more than 100 G force. Further, with acrylic optical parts, solid state and CD type structures comprising the remainder of the DVT, the durability of the device, properly enclosed, can easily match that of analog microphones designed for the most demanding environments. The only component of the DVT prone to significant lifetime limitations is the laser. Blue and red solid state diode lasers operating at maximum rated power have lifetime expectancies of over 10,000 hours, or over 13 months of continuous use. When under driven, though, red lasers can surpass 100,000 hours before failure, or over 11 years continuous use. The figure for blue diode lasers is unknown due to their recent development. In any event, the DVT can be designed to use a standardized laser element that is easily replaced.

Ease of manufacturing. The construction of the DVT is typical of the micro fabrication techniques used for VLSI (very large scale integration) chips, CD pressing and precision acrylic molding. A molded framework can be used to which all the components are easily attached leaving only the need for several precision alignments, as with any premium microphone. The mounting of the bearings to the their components will be critical, but no more so than the attachment of a precision copper coil to a diaphragm and aligning it to a magnet, for example. Thus, the DVT can be considered as lending itself to mass production as much as analog microphones do.

Cost. The expense of a copper coil and a high quality magnet are not among those incurred in the manufacture of the DVT. Instead, expense will be concentrated in the bearings, optical components, and perhaps the laser, given that cost of the electronic sections, when formed as VLSI chips, drop dramatically with mass production. The overall cost of the DVT can then be expected to be comparable to the best of its analog counterparts and, at least, commensurate with the exceptional performance of the device.

It is understood that numerous modifications could be made to the embodiments described above without departing from the scope of the invention as defined in the appended claims.

What is claimed is:

1. A digital vibration transducer for producing a digital signal representative of a vibration of a vibrating member, said transducer comprising:
a laser light source for generating a light beam having an optical axis;
focusing means for focusing said light beam on a detection area;
a reflector disposed across the light beam and defining a reflecting plane at an angle from the optical axis, said reflector being pivotable with respect to a pivot axis extending in said reflecting plane, the reflector reflecting the light beam towards the detection area;
a linkage assembly having a first and a second end, the first end being operatively connected to the vibrating member, the second end being operatively connected to the reflector offset the pivot axis, said linkage assembly converting the vibration of the vibrating member into a pivoting of the reflector about said pivot axis and sweeping the light beam reflected thereby across the detection area;
a sensing and encoding assembly for sensing the light beam in said detection area and producing a digital signal encoded relatively to said sweeping thereof, said digital signal defining the digital signal representative of the vibration of the vibrating member.

2. The digital transducer according to claim 1, wherein said laser light source is a collimated solid-state laser diode.

3. The digital transducer according to claim 1, wherein the pivot axis of the reflector intersects the optical axis of the light beam.

4. The digital transducer according to claim 1, wherein said focusing means comprise an optical arrangement disposed between the laser light source and the reflector.

5. The digital transducer according to claim 4, wherein said optical arrangement comprises a dispersing lens and a focusing objective.

6. The digital transducer according to claim 1, wherein the reflector comprises a substrate of optical glass, and a layer of reflective material deposited thereon.

7. The digital transducer according to claim 1, further comprising a bearing assembly for mounting the reflector about opposite extremities of the pivot axis.

8. The digital transducer according to claim 7, wherein said bearing assembly comprises a pair of vee-bearings respectively contacting the reflector at opposed extremities of the pivot axis.

9. The digital transducer according to claim 1, wherein the linkage assembly comprises:
a linkage arm extending between said reflector and said vibrating member;
a linkage-bearing frame having a center portion connected to the linkage arm at the second end of the linkage assembly and two side portions projecting from the center portion on opposite sides of the reflector; and
two bearing members, each connected to a respective side portion of the linkage-bearing frame and to a side surface of the reflector.

10. The digital transducer according to claim 1, wherein the sensing and encoding assembly comprises:
an encoder for encoding the light beam reflected by the reflector; and
a light sensor for sensing the light beam after encoding thereof.

11. The digital transducer according to claim 10, wherein said encoder comprises an elongated plate extending along said detection area, and provided with a plurality of alternating dark and clear stripes perpendicular to the sweeping of the light beam and respectively blocking and allowing said light beam therethrough, said encoder thereby converting the vibrating of the vibration member into light pulses.

12. The digital transducer according to claim 11, wherein said sensing and encoding assembly further comprise a pulse counter for counting said light pulses.

13. The digital transducer according to claim 10, wherein the light sensor comprises a silicon cell spanning the detection area.

14. The digital transducer according to claim 10, wherein said light sensor is a photodiode, said digital transducer further comprising light redirecting means for redirecting said light pulses.

15. The digital transducer according to claim 14, wherein said light redirecting means comprise a curved mirror extending downstream the encoder, said curved mirror redirecting all of said light pulses towards the photodiode.

16. The digital transducer according to claim 10, wherein said encoder comprises an elongated plate extending along said detection area, and provided with a plurality of alternating reflective and non-reflective stripes perpendicular to the sweeping of the light beam and respectively reflecting and preventing reflection of said light beam towards the light sensor, said encoder thereby converting the vibrating of the vibration member into light pulses.

17. The digital transducer according to claim 1, wherein said light beam has a linear cross-section in said detection area extending perpendicularly to the sweeping of the light beam.

18. The digital transducer according to claim 17, wherein the focusing means comprise a cylindrical lens disposed between the reflector and the sensing and encoding assembly.

19. The digital transducer according to claim 17, wherein the reflecting surface of the reflector has a curvature.

20. The digital transducer according to claim 17, wherein the focusing means comprise a cylindrical dispersing lens and a cylindrical focusing objective extending between the light source and the reflector.

21. The digital transducer according to claim 17, wherein the focusing means comprise a dispersing lens, a cylindrical lens and a focusing objective sequentially extending between the light source and the reflector.

22. The digital transducer according to claim 17, wherein said focusing means comprise a diffraction grating, a dispersing lens, and a focusing objective sequentially extending between the light source and the reflector.

23. The digital transducer according to claim 17, wherein the sensing and encoding assembly comprises:
an encoder for encoding the light beam reflected by the reflector, said encoder comprising a plurality of encoding bands extending along said detection area parallelly to the sweeping of the light beam, the linear cross-section of the light beam crossing each of said encoding bands, each of said encoding bands having a plurality of alternating dark and clear stripes perpendicular to the sweeping of the light beam and respectively blocking and allowing said light beam therethrough, the stripes of neighboring encoding bands being offset each other, the encoding bands thereby converting the vibrating of the vibration member into offset sequences of light pulses; and
a plurality of light sensors each sensing one of said sequences of light pulses.

24. The digital transducer according to claim 1, wherein the sensing and encoding assembly comprises a photosensitive array.

25. The digital transducer according to claim 24, wherein said photosensitive array is a CCD array.

26. The digital transducer according to claim 23, further comprising a comparator circuit for receiving said sequences of light pulses from the light sensors and deducing therefrom said digital signal representative of the vibration of the vibrating member.

27. The digital transducer according to claim 1, wherein said reflector comprises:
two end mirrors extending on either sides of the pivot axis; and
a frame member connecting said end mirrors together.

28. The digital transducer according to claim 27, further comprising a bearing assembly connected to the frame member for pivotally mounting the reflector about the pivot axis.

29. The digital transducer according to claim 28, wherein said bearing assembly comprises:
a rod rigidly affixed to the frame member and extending along the pivot axis; and
a pair of vee bearings connected to respective ends of said rod.

30. The digital transducer according to claim 28, wherein said bearing assembly comprises a suspension wire for suspending the frame member about the pivot axis.

31. The digital transducer according to claim 27, further comprising a beam splitter for splitting the light beam into two light beam components respectively directed towards each of the end mirrors.
